(19) United States
(12) Patent Application Publication
(10) Pub. No.: US 2008/0043485 A1
(43) Pub. Date: Feb. 21, 2008

(54) LENS ATTACHMENT FOR A HEADLAMP

(76) Inventors: Steffen Koerner, Delligsen (DE); Matthias Kalwa, Lippstadt (DE); Tilmann Maucher, Lippstadt (DE)

Correspondence Address: HARNESS, DICKEY & PIERCE, P.L.C., P.O. BOX 828, BLOOMFIELD HILLS, MI, 48303, US

(21) Appl. No.: 11/840,613

(22) Filed: Aug. 17, 2007

(30) Foreign Application Priority Data
Aug. 18, 2006 (DE) 10 2006 039 705.3

(51) Int. Cl. F21V 5/00

(52) U.S. Cl. 362/521

(57) ABSTRACT

The invention discloses a lens attachment for headlamp being particularly suited for a motor vehicle and having a plurality of LEDs, with each LED is aligned with one lens. The lenses are assembled to a lens package and are located one relative to the other by connection elements. The lens package may be received in a suitable mounting frame for locating the package relative to the LEDs.

### RELATED APPLICATIONS

This application claims Convention priority of German Patent Application No. 10 2006 039 705.3 filed on Aug. 18, 2006, the content of which is fully incorporated by reference herewith.

### BACKGROUND OF THE INVENTION

The present invention relates to a lens attachment for a headlamp having a plurality of LEDs and a plurality of individual lenses. The invention further relates to a headlamp having a plurality of LEDs and a lens attachment of that kind.

Recent developments in the field of motor vehicle headlamps attempt to further reduce energy consumption and yet to achieve adequate illumination of the roadway. While previously Xenon light sources have set the standard for high-quality headlamps, developments have been dedicated most recently to LED headlamps. In order to produce a predefined illumination pattern, the specifications of which normally are defined by the respective legislation, it has been proposed to assign one lens to each LED. In most of the cases, a headlamp comprises a greater number of LEDs, normally from two LEDs up to approximately ten or twelve LEDs.

A LED headlamp of that kind having twelve LEDs has been known from US 2004/0223337 A1, where one lens is assigned to each LED. The individual LEDs are received in a frame which is connected with a base plate on which the LEDs are supported.

According to WO 2006/034329 A2, only one or two lenses of an array of LEDs are used to produce a predefined illumination pattern. In that respect, glass-fiber cables are used to meet the predefined illumination pattern.

WO 2004/059207 A1 describes the combination of an LED array with a common convex lens by which the predefined illumination pattern is to be met.

In the case of the known solutions, either the structure is relatively complex or, in cases where a single common lens is used to generate the illumination pattern, it is not guaranteed that the predefined specifications can be met without any problem.

### SUMMARY OF THE INVENTION

In view of this it is a first object of the present invention to provide a lens attachment for a headlamp having a plurality of LEDs, which makes the structure of the headlamp as simple and economical as possible.

It is a second object of the present invention to provide a lens attachment for a headlamp having a plurality of LEDs, each of which is aligned with an associated lens.

It is a third object of the present invention to provide a lens attachment for a headlamp that facilitates a good compliance with the public or governmental specifications for a predefined illumination pattern.

It is a forth object of the present invention to provide a headlamp that is easy to manufacture but still ensures a good compliance with the public or governmental specifications for a predefined illumination pattern.

These and other objects are achieved by a lens attachment for a headlamp with a plurality of LEDs, comprising a plurality of individual lenses that are assembled to a lens package and are located one relative to the other by connection means.

The object of the invention is further achieved by a headlamp, in particular, a motor vehicle headlamp, having a plurality of LEDs with a lens assigned to each of the LEDs for generation of a predefined illumination pattern, the lenses being assembled to a lens package and being located one relative to the other by connection means.

The object of the invention is perfectly achieved in this way.

The number of lenses preferably corresponds to the number of LEDs in the headlamp so that an especially adapted lens can be used for each LED in order to obtain an optimized illumination pattern for the headlamp.

The fact that the lenses are produced as separate lenses and are then assembled to a lens package results in a clear reduction in the costs of manufacture, compared with a solution where the lenses are produced jointly. The individual lenses can be produced by an efficient process, for example by molding, and can then be combined to a lens package in a manner that guarantees correct positioning of the individual lenses.

As a result, only the lens package needs to be correctly positioned relative to the LEDs in order to guarantee conformance with the optical parameters of the headlamp. This clearly reduces the costs of assembly and simultaneously improves the stability of the optical system.

According to an advantageous further development of the invention, the lenses have mutually parallel joint surfaces on the sides that face each other.

Correct positioning of the lenses one relative to the other and permanent connection of the lenses one with the other are thereby facilitated.

According to another embodiment of the invention, the sides of the lenses are connected one with the other by a bonding material.

According to a first variant of that embodiment, the sides of the lenses are connected one with the other by an adhesive.

According to a second variant, the sides of the lenses are connected one with the other by a glass solder.

These features facilitate safe connection of the lenses and simultaneously simplify production of the lenses.

Preferably, the joint surfaces of the lenses are connected one with the other without any gaps.

This guarantees especially high stability of the lens package.

According to another preferred embodiment of the invention, the lenses are connected one with the other by a light-absorbing material.

One thereby avoids potential stray light between one lens and a neighboring lens so that any impairment of the predefined illumination pattern of a headlamp by unwanted stray light is prevented.

According to another embodiment of the invention, the lenses are connected with a common mounting element, preferably in the form of a plate, by connection elements, preferably by fasteners or screws.

The connection elements preferably are optically transparent in this case.

The connection elements may engage in bores that are filled with casting compounds.

According to a further embodiment of the invention, the connection elements extend in the axial direction of the lenses and are perceptible when viewed from the effective reflex surface. This allows the unavoidable visibility, if any, of the connection elements to be utilized for decorative purposes, for which purpose the connection elements or surfaces may be given different colors or a metallic appearance.

The casting compounds may be used to minimize the degree of visibility of the bores and of the connection elements.

According to a further embodiment of the invention, the lens package is supported at defined contact points on a mounting frame that comprises closely toleranced contact surfaces for locating the lens package in relation to the LEDs.

That feature facilitates the operation of locating the lens package in a headlamp relative to the associated LEDs.

The lens package may be supported on the mounting frame by an adhesive joint and/or by clamping.

According to a further embodiment of the invention, the lens package is placed in the mounting frame by an injection process.

The mounting frame may consist of sheet metal or of a plastic material, for example.

These features facilitate the operation of positioning the lens package in a headlamp relative to the LEDs and reduce the assembly and adjusting expense.

According to a further embodiment of the invention, at least some of the lenses comprise a recess, in particular a groove, for accommodating a mounting element intended to locate the lens package relative to the LEDs.

This feature likewise helps achieve easy and correct positioning of the lens package relative to the LEDs.

It is understood that the features of the invention mentioned above and those yet to be explained below can be used not only in the respective combination indicated, but also in other combinations or in isolation, without leaving the scope of the invention.

### BRIEF DESCRIPTION OF THE DRAWINGS

Further features and advantages of the invention will become apparent from the description that follows of preferred embodiments of the invention, with reference to the drawing. In the drawings:

FIG. 1 shows a perspective view of a first embodiment of a lens package according to the invention, combined with a mounting frame;

FIG. 2 shows the general structure of a headlamp according to the invention using a lens package according to the invention that has been slightly modified compared with the embodiment of FIG. 1;

FIG. 3 shows a cross-section through another embodiment of a lens package according to the invention; and

FIG. 4 shows a cross-section through a modified embodiment of a headlamp according to the invention.

### DETAILED DESCRIPTION OF THE PREFERRED EMBODIMENTS

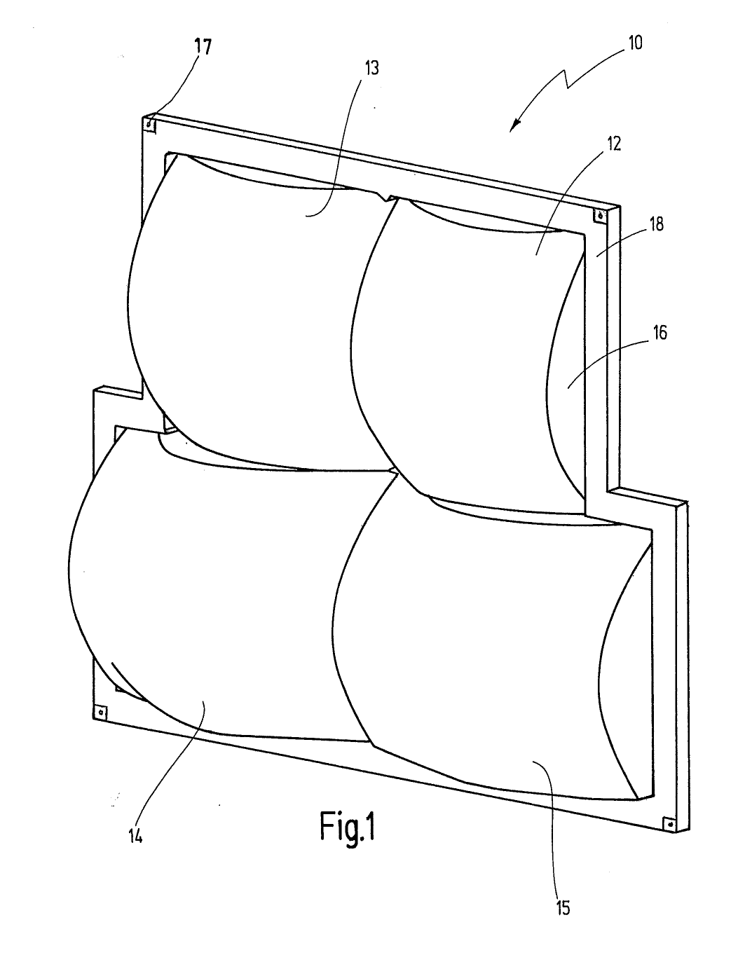

A first embodiment of a lens package according to the invention is illustrated in FIG. 1 and is indicated generally by reference numeral 10.

The lens package 10 comprises four lenses 12, 13, 14, 15, the imaging characteristics of which are adapted to the respective assigned LEDs of a headlamp (not shown). The sides of each lens 12, 13, 14, 15 are each provided with a flat joint surface 16, and the oppositely arranged joint surfaces of one lens extend in parallel one to the other and in parallel to the optical lens axis. The joint surfaces on the upper and lower surfaces of the respective lens likewise extend in parallel one to the other and intersect the joint surfaces on the sides at an angle of 90°. The lenses 12, 13, 14, 15 are bonded one to the other by their adjoining joint surfaces and are additionally received, by their outer joint surfaces, in a correspondingly shaped mounting frame 18. During that operation, they are simultaneously secured to the mounting frame by bonding.

The lenses 12, 13, 14, 15 are bonded one to the other without any gaps by their mutually parallel flat joint surfaces using an adhesive so that a compact unit is obtained. The adhesive used is colored to make it light-absorbing in order to prevent any undesirable stray light from one lens to another lens. For producing the bond between the joint surfaces of the lenses 12, 13, 14, 15, the lenses are initially placed in a suitable device and are correctly aligned one with respect to the other so that, once bonding between the lenses has been effected, the lenses are not only connected one with the other to form a lens package, but are simultaneously correctly located one relative to the other.

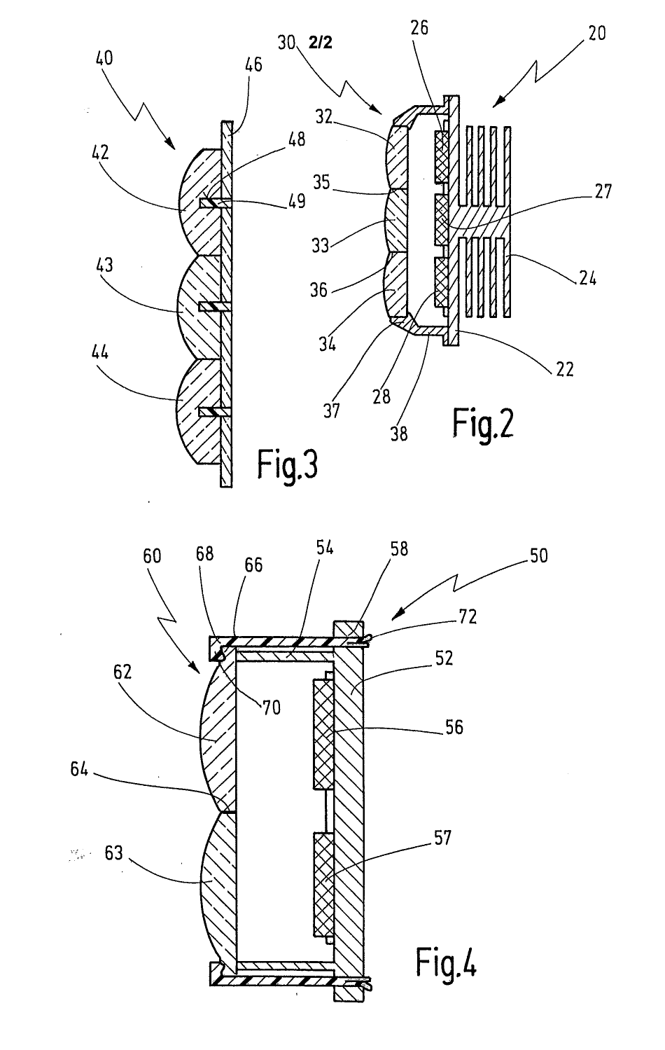

That operation is followed by bonding of the lens package 10 to the mounting frame 18, again at predefined contact points 17, which again may be effected using a suitable device in order to guarantee correct alignment of the lens package 10 relative to the mounting frame 18. In FIG. 1 four contact points 17 are shown at the outer corners of the mounting frame 18. Each contact point 17 is configured as a closely toleranced small recess into which an associated connecting element (not shown) engages for positioning the mounting frame 18 together with the lenses 13 with respect to a common base (such as shown in FIG. 2 or 3).

If desired, the assembly operation may be combined with the operation of bonding the lenses together to form a lens package.

Similar contact points may be used for correctly positioning the assembled lens package within a headlamp.

FIG. 2 shows the general structure of a motor vehicle headlamp using such a lens package, indicated generally by reference numeral 20. The lens package 30 illustrated in FIG. 2 has been slightly modified compared with the lens package 10 according to FIG. 1, but the lenses 32, 33, 34 are again continuously bonded one to the other by their sides via joint surfaces using an adhesive 35, 36. In contrast to the embodiment of FIG. 1, the three lenses 32, 33, 34 are now arranged one above the other, with four such rows of lenses provided one beside the other so that a headlamp having a total of twelve individual lenses is obtained.

Further, the lenses are bonded in this case to a mounting frame 37, which simultaneously is designed for being mounted on a base body 22 of the headlamp 20. Mounting can be effected, for example, by screwing, riveting, snapping-in, etc. (not shown). The base body 22 has a plate-shaped design and is provided with a series of cooling ribs 24 on its side opposite the lens package 30. The base body 22 may consist of aluminum, for example. The front surface of the base body 22 carries LEDs 26, 27, 28, which are supported on that surface via a printed board and suitable intermediate insulating pads or the like (not shown). Each of the LEDs 26, 27, 28 is aligned along the optical axis relative to an associated lens 32, 33, 34, respectively, of the lens package 30.

It is understood that as a rule the headlamp 20 will additionally comprise a suitable housing (for example an aluminum housing) and a suitable front cover (as a rule made from a plastic material) as well as adjusting means for adjusting the headlamp. And the electric connections have been omitted in the drawing as well, for the sake of simplicity.

FIG. 3 shows a cross-section of a modified embodiment of a lens package, which is generally indicated by reference numeral 40. In this case, an array comprising twelve individual lenses is connected with a mounting element 46 in the form of glass plate via connection elements 49 in the form of fasteners. Again, groups of three lenses 42, 43, 44 are arranged one above the other and are in contact one with the other by flattened joint surfaces. Each of the lenses 42, 43, 44 is provided with a bore 48, extending in the direction of their optical axes, which is engaged by a transparent plastic fastener 49 that extends through a corresponding bore in the mounting element 46, ending flush with the latter's outer surface. The fasteners may be sealed in addition by a casting compound.

If desired, the fasteners used may by metallized or optically tinted fasteners that enhance the optical design of the lens package 40 and that are visible when viewed from the front of the lenses. The mounting element 46 in the form of a glass plate simultaneously serves to locate the lens package during installation in a headlamp.

A further modification of a headlamp according to the invention is illustrated in FIG. 4 and is indicated generally by reference numeral 50.

The headlamp 50 again comprises a base body 52 in the form of a plate, preferably made from aluminum. The cooling ribs on the rear surface have been omitted in the drawing for reasons of simplicity. An array of LEDs is fixed on the front of the base body in a suitable way. The array may for example comprise 3×2 LEDs, with groups of two LEDs 56, 57 arranged one above the other and three rows of LEDs provided one beside the other, as shown in FIG. 4.

Here again, each LED 56, 57 has assigned to it one lens 62, 63, the lenses 62, 63 (and their neighboring lenses)—not visible in FIG. 4—being connected by their mutually parallel joint surfaced by a bonding material to form a lens package 60. In contrast to the lens package 30 illustrated in FIG. 2, bonding is not effected in this case using an adhesive, but rather using a glass solder 64.

Using a glass solder provides higher thermal loading capacities, compared with the use of an adhesive.

Instead of a mounting frame 18 or 37, as used in the embodiments according to FIG. 1 or 2, and instead of a mounting plate 46, as used in the embodiment according to FIG. 3, grooves 66 provided at the edges of the lenses 62 may be employed for correct positioning of the lens package 60 relative to the base plate 52. The grooves 62 preferably are provided in the outer edge of either the front or the side and may be produced either during production by a molding operation or subsequently by grinding. The grooves 66 serve to receive mounting elements 68 with suitable projections 70 that engage the grooves 66, thereby fixing the lens package 60 on the base body 62. The base body 62 may be provided with suitable positioning elements 54 which may project in the direction of the lens package 60, for example in the form of pins, thereby determining the spacing between the lens package 60 and the base plate 52. The mounting elements 68 may for example engage in bores 58 of the base plate 52 and may be designed for being locked in place using locking elements 72.

In this way, correct positioning and mounting of the lens package 60 on the base plate 52 in the correct location is ensured by especially simple means.

In all illustrated embodiments, the lens surfaces facing the LEDs 26, 27, 28 and 56, 67, respectively, have a flat shape while the lens surfaces facing away from the LEDs show an outwardly directed convex curvature. Each lens 12 to 15, 32 to 34, 42 to 44 and 62, 63, respectively, has its imaging characteristics adapted to the respective mating LED so as to generate, in combination with the LED, the desired overall radiation characteristics of the headlamp in order to ensure that the predefined specifications for an illumination pattern (for example for a dimmed-beam pattern) can be met.

What is claimed is:

1. A lens attachment for a headlamp, comprising:
a plurality of LEDs supported on a first base; and
an array of individual lenses that are assembled to a lens package;
wherein said lens package comprises:
a second base;
and a mount for securing said lenses;
wherein said lens package is positioned with respect to said first base so that each of said lenses is aligned with one of said LEDs.

2. The lens attachment of claim 1, wherein said first base is configured as a plate.

3. The lens attachment of claim 1, wherein said lenses comprise side surfaces which are mutually parallel to each other.

4. The lens attachment of claim 3, wherein said side surfaces are connected one with the other by a bonding material.

5. The lens attachment of claim 3, wherein said side surfaces are connected one with the other by an adhesive.

6. The lens attachment of claim 3, wherein said side surfaces are connected one with the other by a glass solder.

7. The lens attachment of claim 3, wherein said side surfaces of said lenses are connected one with the other substantially without any gaps.

8. The lens attachment of claim 3, wherein said lenses are connected one with the other by a light-absorbing material.

9. The lens attachment of claim 1, further comprising a plurality of fasteners for mounting said lenses on said second base.

10. The lens attachment of claim 9, wherein said fasteners are optically transparent.

11. The lens attachment of claim 9, wherein at least some of said lenses comprise bores which are engaged by said fasteners and which are filled with casting compounds.

12. The lens attachment of claim 9, wherein said fasteners extend in an axial direction of said lenses and are arranged so as to be optically visible when viewed from the outside.

13. The lens attachment of claim 1, wherein said second base is configured as a mounting frame on which said lenses are supported.

14. The lens attachment of claim 13, wherein said lenses are supported on said mounting frame by a mount selected from the group formed by an adhesive joint, a clamping element, and a joint formed by injection molding.

15. The lens attachment of claim 1, wherein said second base comprises pre-defined contact points having closely toleranced contact surfaces which are configured for mating with associated contact points on said first base on which said lenses are positioned for positioning said lens package in relation to said LEDs.

16. The lens attachment of claim 1, wherein said first base and said second base are identical.

17. The lens attachment of claim 1, wherein at least one of said lenses comprise a recess which is engaged by a fastener for positioning said lens package with respect to said LEDs.

18. A lens attachment for a headlamp, comprising:
a plurality of LEDs supported on a base;
an array of individual lenses defining a lens package;
a plurality of fasteners for securing said lens package on said base;
wherein said lens package is positioned with respect to said base so that each of said lenses is aligned with one of said LEDs.

19. A headlamp comprising a first plurality of LEDs and a second plurality of lenses for commonly generating a predefined illumination pattern;
wherein said first plurality of LEDs and said second plurality of lenses are combined into a lens attachment, said lens attachment comprising:
a plurality of LEDs supported on a base; and
an array of individual lenses that are assembled to a lens package;
wherein said lens package comprises:
a common mounting base;
and a plurality of connecting elements for securing said lenses; and
wherein said lens package is positioned with respect to said common mounting base so that each lens of said second plurality of lenses is aligned with one LED of said first plurality of LEDs.

20. The headlamp of claim 19 which is configured as a motor vehicle headlamp.
